(19) United States
(12) Patent Application Publication
(10) Pub. No.: US 2015/0183126 A1
(43) Pub. Date: Jul. 2, 2015

(54) Box Joint Jig for Machine Tables

(71) Applicant: Carl Edward Korschgen, Columbia, MO (US)

(72) Inventor: Carl Edward Korschgen, Columbia, MO (US)

(21) Appl. No.: 14/145,981

(22) Filed: Jan. 1, 2014

(51) Int. Cl. B27F 1/12; B27B 25/10

(52) U.S. Cl. CPC B27F 1/12; B27B 25/10

(57) ABSTRACT

This box joint jig for machine tables is an accessory primarily for stationary woodworking machines that have 1) a work table, 2) embedded miter gage slot(s) or parallel sides that function as guides, and 3) cutting blades or cutting bits such as found on table saws or router/shaper. The box joint jig herein described is a device that is used with these machines to efficiently and precisely cut the joint components conventionally called box joints or finger joints that have a series of interlocking rectangular notches on connecting boards. Multiple sides of boxes can be accurately jointed simultaneously on the apparatus because of its sled, sliding box, and flipper design. A machine requirement is that it can be used with various cutting tools such as saw blades, dado blades, or shaper/router bits that can cut square notches in the ends of boards.

### CROSS-REFERENCE TO RELATED APPLICATIONS

This application claims the benefit of provisional patent application Ser. No 61/761,816, filed 2013 Feb. 7 by the present inventor.

### BACKGROUND OF THE INVENTION

1. Field of Invention

This invention is relevant to the woodworking and cabinetry field. The jig herein described is for making corner joints for the assembly of wooden containers such as storage boxes, chests, furniture drawers, or beehives. The joint which is the subject of this invention is commonly referred to as a box or finger joint because of the way that offset cuts in the ends of the boards interlock with each other to form a strong and durable structure. There is a need for a jig that is quick to set up on the machine table and offers the capability to cut multiple joint components in an accurate and safe manner.

2. Prior Art

The following are patents related to the subject concept. They are listed because they illustrate the complexity of other jigs and they are relevant to the making of box joints and possibly dovetail joints.

| | Kind | | |
|---|---|---|---|
| Pat. No. | Code | Issue Date | Patentee |
| 2,972,366 | | 1961-2-21 | Caruso |
| 4,693,288 | | 1987-9-15 | Buechele et al. |
| 4,776,374 | | 1988-10-11 | Charlebois |
| 4,809,755 | | 1989-3-7 | Pontikas |
| 5,143,132 | | 1992-9-1 | Keller |
| 5,711,356 | | 1998-1-27 | Grisley |
| 5,890,524 | | 1999-4-6 | Tucker et al. |
| 6,041,837 | | 2000-3-28 | Hanson |
| 6,076,575 | | 2000-6-20 | Harkness |
| 6,095,024 | | 2000-8-1 | Brutscher et al. |
| 6,206,060 | B1 | 2001-3-27 | Blake |
| 6,315,017 | B1 | 2001-11-13 | Stottman |
| 6,588,468 | B1 | 2003-7-8 | Tucker, et al. |
| 7,082,974 | B1 | 2006-8-1 | Vice |
| 7,347,233 | B2 | 2008-3-25 | Freidlund |
| 7,455,089 | B2 | 2008-11-25 | McDaniel |
| 7,594,526 | B2 | 2009-9-29 | Freidlund |
| 7,857,020 | B2 | 2010-12-28 | McDaniel |

3. Description of the Prior Art

Historically, joinery techniques have evolved from cutting or milling the ends of boards with hand saws and chisels to using power tools to assemble the sides of wooden boxes. Various complex joints such as box/finger joints and a series of dovetail joints have been for machines such as table saws, routers, and specialized machines. Joining boards to form a square or rectangular structure requires that repetitive and precise cuts be made in the matching ends of the boards. Box joints differ from dovetail joints in that dovetail joints must be cut into the two opposing ends of the boards simultaneously, perpendicular to each other, and one corner joint at a time. The jig herein described is for cutting box/finger joints exclusively. Multiple parallel boards making up the sides of a box or boxes can be jointed simultaneously or independently with this jig by offsetting the opposing sides so that the cut notches will interleave. Box joints are a preferred joint because of the strength of the long-grain to long-grain contact between the notches, which provides a solid gluing and fastening surface.

Most joinery applications require the precise and repeatable cutting of square notches in the ends of materials. Modern power tools can make this process efficient but can also be a very dangerous operation unless the workpieces are securely fastened to a holding device and the fingers and hands of the worker are completely isolated from the rotating cutting tools such as saw blades, dado blades, or router bits. Therefore, a jig is essential for the quality of the product and the safety of the worker. There are many variations of jigs for cutting box joints but few provide the simplicity of operation and safety as the jig described in this invention.

The challenge of making box/finger joints is to move whatever device is holding the workpieces to the next cutting position or to move the workpieces to the next cutting position. Over time, many jigs have been developed to do this by using threaded rods, notched wheels, gears, or indexing pins. An apparatus with these features is often mechanically complex, expensive to manufacture, difficult to calibrate, and not easily adaptable to changing joint sizes. Additionally many of these devices do not permit the cutting of multiple workpieces simultaneously.

### BRIEF SUMMARY OF THE INVENTION

This new carpentry jig is an accessory primarily for stationary woodworking machines that have 1) a work table, 2) embedded miter gage slots, and 3) cutting blades or bits such as found on table saws or router/shaper tables. The box jig herein described is a device that is used with these machines to efficiently and precisely cut the joint components. A machine requirement is that it can be used with various cutting tools such as saw blades, dado blades, or shaper/router bits that can cut square notches of various widths in the ends of boards.

This jig overcomes many of the disadvantages of an accessory for stationary woodworking machines. It takes advantage of the machine's work table, embedded miter gage slots, and cutting blades or bits. It is used to make box joints (also called finger joints) using a sled and sliding box design on a table saw or router/shaper table. The sled is an open box made with two rails, a bottom piece, one end piece, and two miter gage slot runners fastened to the underside of the jig's bottom. The sled is calibrated to the machinery table and is designed to move forward and backward along the machine table using the miter slots as guides. A sliding box, with potentially multiple configurations, is precisely mounted inside the sled using tongue and groove attachments such that the sliding box is suspended above the bottom of the sled. The sliding box moves from side to side inside the sled. Multiple workpieces are clamped into the sliding box and box joints are cut as the sled is pushed through the cutting tool which may be a saw blade, dado blade, or router/shaper bit. A sliding box that is suspended inside the sled moves from side to side as the flippers accurately space the workpieces to the next cutting position. Compared to most other commercially available jigs, this invention is simple to construct because of the relatively small number of parts, is easy to use, and it provides efficient and accurate results.

The major advantage of the invention is that it provides a fast and simple method for indexing the placement of the workpieces in the path of the cutting tool using a series of flippers on a sled and sliding box assembly.

Another advantage of the invention is that the construction of the jig is scalable for any number of boards, limited only by the size of the machine work table and the power of the machine. The size of the jig can be made to permit the clamping of multiple boards at a time, depending upon the thickness of the boards.

Another advantage is that once workpieces are clamped into the sliding box they are not reclamped until all the joints are cut on one end of the workpieces.

Another advantage of the invention is that the construction of the jig can be customized to make any size of box joint that is desired by changing the width of the cutting tool and the flippers (nominally need to be the precise twice the width of the cutting tool).

Another advantage of the invention is that the mounting hole for the individual flippers can be drilled on both the thickness and width dimensions, providing a capability to make box joints of two different widths with the same set of flippers and the same sled and sliding box.

Another advantage of the invention is that a separate array of flippers can be fabricated to make joints that are incrementally two or three times greater than the width of the cutting tool.

Another advantage of the invention is that the construction of the jig is scalable for any width of boards making up a box.

Another advantage of the invention is that the jig can be used to cut joints in the paired sides of a box independently, thus decreasing clamping time within the sliding box. The other matching pairs of boards would be offset by the width of the cutting tool and cut during a second pass.

Another advantage of the invention is that the starting point of the joints on the corners of a box can be adjusted to eliminate a less than desirable notch joint width on the top or bottom of the workpieces.

Another advantage of the invention is that the construction of the jig includes a safety guard that provides for greater protection of the fingers and hands of the operator and deflects wood chips from the cutting tool along the machine table and away from the operator.

### BRIEF DESCRIPTION OF THE SEVERAL VIEWS OF THE DRAWINGS

FIG. 1 is a perspective view of one scale of a complete box joint jig mounted on the table of a table saw machine. Two miter gauge slots are shown. The cutting tool, a standard dado blade, protrudes through the machine table midway between the two miter gauge slots and under the jig. The jig's three major components, the sled assembly, the sliding box assembly, and the flipper array are shown.

FIG. 2 is another perspective of the complete box joint jig showing how the flippers rotate from the up to the down position.

FIG. 3 is an illustration of a box joint that shows the interleaving of the ends of matching workpieces.

FIG. 4 is a perspective view of the details of the sled of the box joint jig.

FIG. 5 is a perspective view of the details of the sliding box of the box joint jig.

FIG. 6 is a detailed view of the flippers arrays (A and B) used with the box joint jig. Dimensions and repeating pattern determine the width of the box joint.

FIG. 7. is an illustration showing examples of three sizes of offset keys used with the box joint jig. Workpieces are offset in the box joint jig by multiple pairs as shown in A, B, and C.

### DETAILED DESCRIPTION OF THE INVENTION

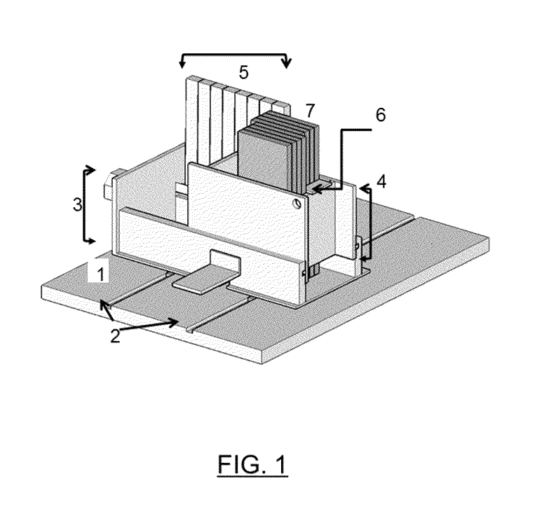

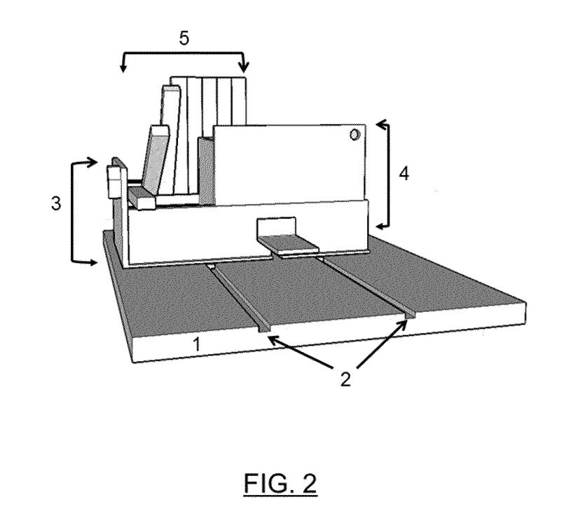

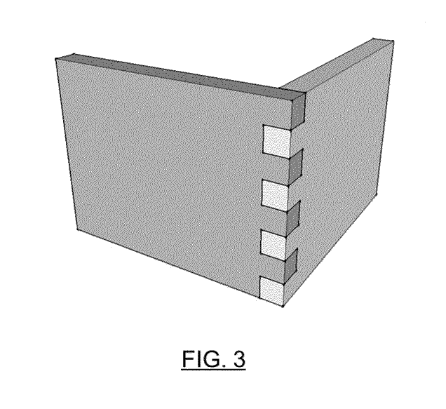

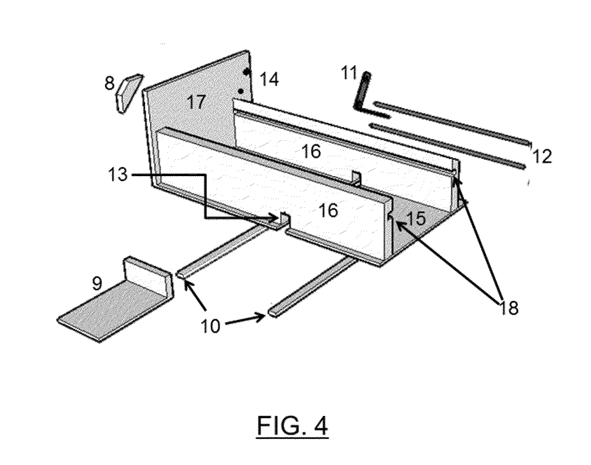

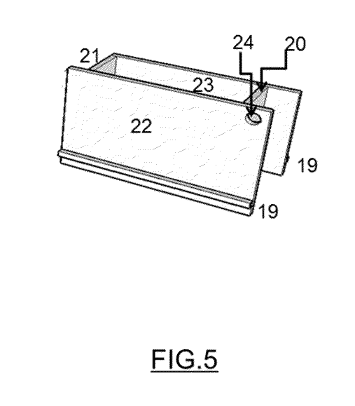

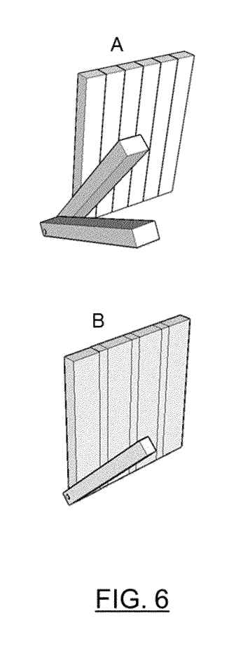

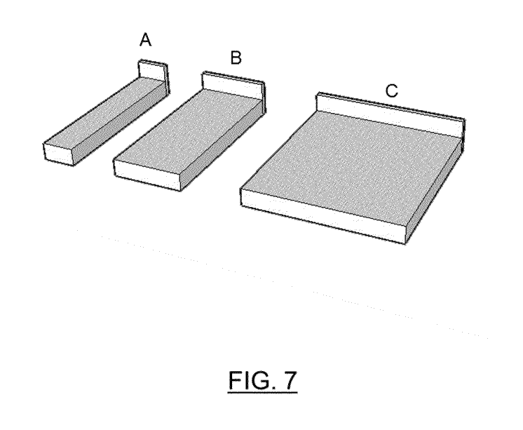

As shown in a FIGS. 1 and 2, this box joint jig is based on a design that incorporates 1) a sled, 2) a sliding box, and 3) a series of flippers that are totally unique to previous inventions. All components of the box joint jig are scalable to match the size and quantity of the items being manufactured. The box joint jig herein described could be constructed from plywood, lumber, cast metals, or injected plastics. The intention of this jig is to provide an accessory for woodworking machines that is easier and less expensive to construct, more efficient to set up and use, and safer than most previously available jigs for making box joints as shown in FIG. 3. FIGS. 4-5 show detailed views of the sled and sliding box components of the box joint jig. FIGS. 6 and 7 show configurations of the flipper arrays and offset keys.

### Construction:

1) FIGS. 1 and 2 show how the sled assembly 3 is calibrated and held to the machinery table 1 using the miter gage slots 2 of the machine table. The jig assembly could also be calibrated to a machine table that has only one miter gage slot by using an open edge of the table that is parallel with the miter gage slot. On table saws the cutting blade, either a saw or dado blade, is approximately in the middle of the machine table and between the two miter gage slots. Router machine tables have the cutting bit in the middle of the table. The sled is designed to move forward and backward along the machine table. As shown in FIG. 4, the sled is three-sided open box made with two wooden side rails 16, an end piece 17, a bottom 15, two miter gage slot runners 10, and a safety guard 9. A groove FIG. 4 18 is cut with a dado blade or router bit into the insides of the sled side rails 16 to accommodate the guides affixed to the sliding box 4 as shown in FIG. 5. The safety guard FIG. 4 9 is affixed to the front of the sled over the path of the cutting tool slot 13 to protect the operator from the cutting tool and wood debris fragments.
2) The sliding box assembly FIG. 1 4 moves from side to side inside the sled FIG. 1 3 and perpendicular to the movement of the sled. FIG. 5 shows that the sliding box has four sides and it is suspended above the bottom of the sled using guides 19 that fit into the grooves FIG. 4 18 cut into the side rails FIG. 4 16 of the sled. The length, width, and height measurements of the sliding box are determined by the anticipated size of the workpieces required in the final product being manufactured. The front panel of the sliding box can be higher than the back panel to allow for easy clamping of work pieces inside the sliding box using standard bar or pipe clamps. A hole can be drilled into the upper right hand corner of the front of the sliding box to accommodate the pipe of a standard pipe clamp which has been assembled separately on both sides of the front of the sliding box. The sliding box is suspended an appropriate distance above the bottom of the sled so that the cutting tool does not cut the bottom of the front and back sides of the sliding box.
3) Flippers can be fabricated from wood, metal, or plastic spacers and are mounted on a steel rod so that they can be easily rotated from the up to down position and vice versa as needed. The flippers, as shown in FIGS. 1,2, and 6, are exact spacers used to incrementally adjust the position of the sliding box within the sled after pushing the sled through the cutting tool. The width of the flippers is determined by the width of the cutting tool—precisely twice the width of the cutting tool for a joint the width of the cutting tool. If a wider box joint is needed, the flippers are changed to a different array configuration such as shown in FIG. 6 B that provides the desired pattern. Flippers may be manufactured and drilled in two directions to provide for the cutting of joints of two different widths. When the flippers are rotated into the up position they are supported by holes in the left side of the sled and a metal rod affixed to the back rail of the sled by a metal bracket that is angled backwards so that the flippers have clearance as the sliding box moves within the sled. In the up position the flippers are just past the vertical position. There are other options for supporting the flippers.

### Use:

To use the box joint jig the operator first places all of the workpieces into the sliding box and offsets, using an offset key FIG. 1 6 and FIG. 7, one of the paired sides. The workpieces are then securely clamped towards the right front corner of the box. The flippers are put in the up position and the operator holds the sliding box to the left side (home position). The sliding box is firmly held to the left as the sled is pushed into the cutting tool. The jig is pushed through the cutting tool until the cutting tool has passed through all of the workpieces. The entire jig is then pulled back to the front of the machine table and the leftmost flipper is lowered and the sliding box is pushed sideways to the home position. The sliding table is then pushed through the cutting tool again. This process is repeated until the workpieces in the sliding box no longer engage the cutting tool and the necessary flippers are in the down position. Half of the joints are now cut. The operator then releases clamps holding the workpieces in the sliding box and vertically flips the entire stack of workpieces. The same paired workpieces are again offset and clamped to the sliding box. The operator then repeats the above procedure in reverse until all of the flippers are in the up position. All of the joints should now be cut. The work pieces are then removed from the jig and the product assembled using glue and metal fasteners.

Therefore, my box joint jig is potentially simpler to construct, safer to use, more efficient, and more productive than previous inventions. The basic design of the box joint jig can be customized in several ways that might include:

1) Permanently affixed workpiece clamping systems.

2) A series of interchangeable flippers of nominal widths.

3) A series of spacers that could be placed inside the sliding box to expedite clamping of the work pieces.

4) The fabrication of customized sliding boxes for increased production of various workpieces.

5) A series of customized shim boxes to facilitate clamping of workpieces.

1. I claim an apparatus (herein referred to as a box joint jig) for making a woodworking joint commonly called a box or finger joint that is based on a design that comprises a 1) sled, 2) a sliding box, and 3) an array of rotating flippers that are affixed to the sled with a rod.
I claim that the series of rotating flippers that are used to index the sliding box across the sled which has been calibrated to the machine table is a unique invention. The jig can be calibrated to the miter gage slots of machine table such as found on a table saws or router tables. All components of the box joint jig are scalable. Components of the jig could be made from lumber, plywood, cast metals, or injected plastics.
